(19) United States
(12) Patent Application Publication
(10) Pub. No.: US 2022/0237947 A1
(43) Pub. Date: Jul. 28, 2022

(54) FACE RECOGNITION AND IDENTIFICATION SYSTEM USING IOT AND DEEP LEARNING APPROACH

(71) Applicants: Bharath Ram Nagaiah, Breinigsville, PA (US); Muhammad Tahir, Riyadh (SA); Adarsh Kumar, Dehradun Bidholi (IN); Surbhi Bhatia, Al Hofuf (SA); Mohammad Khalid Imam Rahmani, Riyadh (SA)

(72) Inventors: Bharath Ram Nagaiah, Breinigsville, PA (US); Muhammad Tahir, Riyadh (SA); Adarsh Kumar, Dehradun Bidholi (IN); Surbhi Bhatia, Al Hofuf (SA); Mohammad Khalid Imam Rahmani, Riyadh (SA)

(21) Appl. No.: 17/723,615

(22) Filed: Apr. 19, 2022

(51) Int. Cl. G06V 40/16; G06V 10/44

(52) U.S. Cl. CPC G06V 40/171; G06V 10/446; G06V 40/161; G06V 40/172

(57) ABSTRACT

The face recognition and identification system comprises a camcorder configured to capture facial image with and without facial accessories; an image pre-processing unit to normalize the captured facial image thereby create window and apply a Haar like features; a feature extraction unit to extract a set of features from the pre-processed facial image; a classifier to classify the set of features in groups including facial image with and without facial accessories; a control unit comprises an artificial intelligence face acknowledgment model to recognize a face and identify a person with and without facial accessories upon comparing the set of features with an image database stored in a cloud server; and a user interface to show the identified person, wherein the user interface concludes the credibility of the individual's face contingent upon the perceived face certainty level, wherein the higher the certainty level the higher the genuineness of the individual.

### TECHNICAL FIELD

The present disclosure relates to face recognition systems, more specifically, a face recognition and identification system using an Internet-of-Things (IOT) and deep learning approach.

### BACKGROUND

The basic contrast is that holders run on the host operating system (OS) in client space, rather than an altogether unique climate, as virtual machines (VMs). These holders are lighter in weight, which makes them broadly more modest than a virtual machine. They can run relating to different applications in customer space, exist along with virtual conditions, and surprisingly run inside no less than one VMs. Compartments are crucial to pushing information to the edge. Many edge devices are worked with process abilities to do extensively more than conventional advancement of data. They can examine approaching information streams utilizing prepared AI models.

Thinking about AI applications, for instance, cameras and visual entryways can recognize circumstances rapidly and ready administrators as opposed to sending information to a focal area. In the current execution, we have fostered a containerized AI-based Face Recognition model utilizing profound learning strategies. Profound Learning (DL) assumes an urgent part in Artificial Intelligence. Profound Learning is a subset of AI. DL is testing, a popular exploration space of AI. About Facial Recognition, profound Learning engages us to achieve more unmistakable exactness than customary AI systems. With customary AI methods, hand-coding is needed for picture location and extraction, while this not required with profound Learning.

It is the AI that comprehends the necessities and addresses formative requirements while zeroing in on maintainability. Generally profound Learning utilizes the neural organization structures. Subsequently it very well may be known as profound neural organizations. The primary objective of the Artificial Intelligence is to make wise machines that can think and settle the errands without the human direction. The security applications should have learning capacity which can learn dependent on the past experiences. Numerous occurrences can be run on a solitary part in a working framework utilizing the compartment-based virtualization.

The holder-based virtualization further develops the application execution. Since every one of the applications can be run on a similar piece, there is asset productivity in this methodology, and it is not difficult to relocate. The driving inspiration to begin this proposition is to examine the capacity and attainability to convey our containerized AI-put together face acknowledgment model with respect to Firefly-RK3399 and Raspberry Pi (IoT gadget). The proposition is separated into two classifications. The First class is to plan the containerized AI based Face acknowledgment application for perceiving the approved client. There are various strategies in calculation advancement. The subsequent class incorporates checking the chance of fostering the model to such an extent that it is viable with numerous designs for instance, ARM (Firefly's engineering).

In the view of the forgoing discussion, it is clearly portrayed that there is a need to have a face recognition and identification system using IOT and deep learning approach.

### BRIEF SUMMARY

The present disclosure seeks to provide an intelligent face recognition and identification system using artificial intelligence.

In an embodiment, a face recognition and identification system is disclosed. The system includes a camcorder configured to capture facial image with and without facial accessories. The system further includes an image pre-processing unit to normalize the captured facial image thereby create window and apply a Haar like features. The system further includes a feature extraction unit to extract a set of features from the pre-processed facial image. The system further includes a classifier to classify the set of features in groups including facial image with and without facial accessories. The system further includes a control unit comprises an artificial intelligence face acknowledgment model to recognize a face and identify a person with and without facial accessories upon comparing the set of features with an image database stored in a cloud server. The system further includes a user interface to show the identified person, wherein the user interface concludes the credibility of the individual's face contingent upon the perceived face certainty level, wherein the higher the certainty level the higher the genuineness of the individual.

In one embodiment, the calculation of the user interface and information is being broke down and checked on the cloud server using artificial intelligence face acknowledgment model.

In one embodiment, the control unit is configured to stream the captured facial image and convey over standard IoT conventions like MQTT, CoAP and so on to send the information to the cloud motors.

In one embodiment, the user interface is configured with a display unit and a set of input and peripheral devices to promote checking services for highly accessible cloud stage and device network stage for information handling and investigation.

In one embodiment, the artificial intelligence face acknowledgment model is intended to identify, catch, and perceive the Face from a picture, wherein the artificial intelligence face acknowledgment model is carried out to such an extent that it works (runs) on various processors like ARM, AMD, X86, Intel, and so on.

In one embodiment, the artificial intelligence face acknowledgment model is configured with one of the central locking system and authentication system to settle on choices for locking or opening the entryway framework as a utilization case and to send the created AI Model in a Docker Container.

In one embodiment, the artificial intelligence face acknowledgment model is allowed to settle on choices dependent on preparing and dataset, wherein numerous countenances and names are planned and are utilized as preparing sets to the framework.

In one embodiment, the artificial intelligence face acknowledgment model utilizes profound learning and picture handling strategies to distinguish the Face in the live transfer video and interaction the edges with the matching countenances from the datasets, in such cases advancements like AI and preparing datasets are utilized to train the framework to do the means in process.

In one embodiment, the cycle incorporates preparing diverse AI calculations are taken and anchored together to get best outcomes using an initial step to recognize the appearances in the edge or an image, which is an extraordinary component for the artificial intelligence face acknowledgment model, where the artificial intelligence face acknowledgment model is allowed to consequently choose faces disregarding different foundations and colors and furthermore it can ensure that the distinguished Face is in great concentration before it recognizes the Face.

In another embodiment, a face recognition and identification method is disclosed. The method includes capturing facial image with and without facial accessories. The method further includes normalizing the captured facial image thereby creating window and applying a Haar like features. The method further includes extracting a set of features from the pre-processed facial image. The method further includes classifying the set of features in groups including facial image with and without facial accessories. The method further includes recognizing a face and identify a person with and without facial accessories upon comparing the set of features with an image database stored in a cloud server. The method further includes showing the identified person, wherein the user interface concludes the credibility of the individual's face contingent upon the perceived face certainty level, wherein the higher the certainty level the higher the genuineness of the individual.

An object of the present disclosure is to provide a face recognition and identification using IOT and deep learning approach.

Another object of the present disclosure is to provide a picked the methods for preparing the calculation to such an extent that it distinguishes the countenances caught by our camera, which is associated with the assistance of CSI connector.

Another object of the present disclosure is to provide a calculation incorporates the idea of Deep Learning which is a subset of Artificial Intelligence.

Another object of the present disclosure is to provide a angles can be changed over again to milestones to consider the central places of the picture and afterward the preparation step is performed utilizing the Support Vector Machine classifier.

Another object of the present disclosure is to provide an exploration work involves the strategy of fostering the containerized AI model and conveying the containerized application on the Raspberry Pi (IoT gadget), which comprises of the ARM processor.

Another object of the present disclosure is to provide a containerized application run with high effectiveness, is versatile and adaptable between various stages, and the containerized application is viable with different structures (ARM, x86, amd64).

Yet another object of the present disclosure is to deliver an expeditious and cost-effective face recognition and identification system.

To further clarify advantages and features of the present disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF FIGURES

These and other features, aspects, and advantages of the present disclosure will become better understood when the following detailed description is read with reference to the accompanying drawings in which like characters represent like parts throughout the drawings, wherein:

FIG. 1 illustrates a block diagram of a face recognition and identification system in accordance with an embodiment of the present disclosure; and

FIG. 2 illustrates a flow chart of a face recognition and identification method in accordance with an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION

For the purpose of promoting an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are exemplary and explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this disclosure belongs. The system, methods, and examples provided herein are illustrative only and not intended to be limiting.

Embodiments of the present disclosure will be described below in detail with reference to the accompanying drawings.

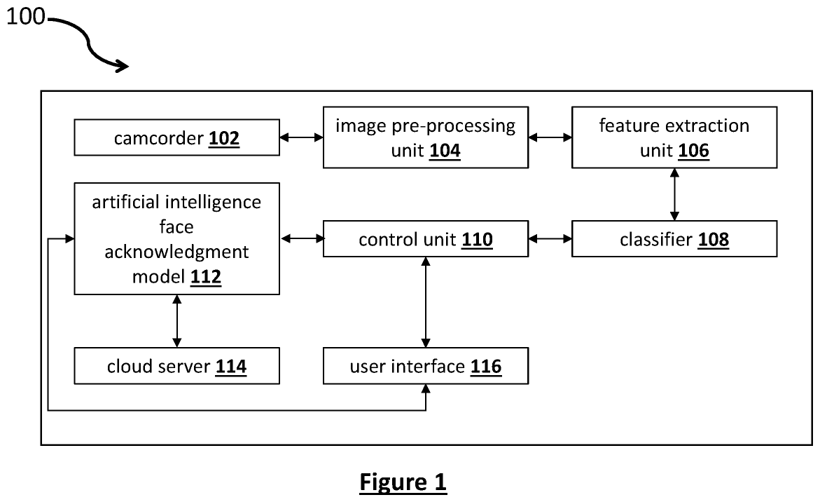

Referring to FIG. 1, a block diagram of a face recognition and identification system is illustrated in accordance with an embodiment of the present disclosure. The system 100 includes a camcorder 102 configured to capture facial image with and without facial accessories. The facial accessories includes eyeglasses, face mask, face jewelries and the like.

In an embodiment, an image pre-processing unit 104 is connected to the camcorder 102 to normalize the captured facial image thereby create window and apply a Haar like features.

In an embodiment, a feature extraction unit 106 is connected to the image pre-processing unit 104 to extract a set of features from the pre-processed facial image.

In an embodiment, a classifier 108 is connected to the feature extraction unit 106 to classify the set of features in groups including facial image with and without facial accessories.

In an embodiment, a control unit 110 comprises an artificial intelligence face acknowledgment model 112 to recognize a face and identify a person with and without facial accessories upon comparing the set of features with an image database stored in a cloud server 114.

In an embodiment, a user interface 116 to show the identified person, wherein the user interface 116 concludes the credibility of the individual's face contingent upon the perceived face certainty level, wherein the higher the certainty level the higher the genuineness of the individual.

In one embodiment, the calculation of the user interface 116 and information is being broke down and checked on the cloud server 114 using artificial intelligence face acknowledgment model 112.

In one embodiment, the control unit 110 is configured to stream the captured facial image and convey over standard IoT conventions like MQTT, CoAP and so on to send the information to the cloud motors.

In one embodiment, the user interface 116 is configured with a display unit and a set of input and peripheral devices to promote checking services for highly accessible cloud stage and device network stage for information handling and investigation.

In one embodiment, the artificial intelligence face acknowledgment model 112 is intended to identify, catch, and perceive the Face from a picture, wherein the artificial intelligence face acknowledgment model 112 is carried out to such an extent that it works (runs) on various processors like ARM, AMD, X86, Intel, and so on.

In one embodiment, the artificial intelligence face acknowledgment model 112 is configured with one of the central locking system and authentication system to settle on choices for locking or opening the entryway framework as a utilization case and to send the created AI model 112 in a Docker Container.

In one embodiment, the artificial intelligence face acknowledgment model 112 is allowed to settle on choices dependent on preparing and dataset, wherein numerous countenances and names are planned and are utilized as preparing sets to the framework.

In one embodiment, the artificial intelligence face acknowledgment model 112 utilizes profound learning and picture handling strategies to distinguish the Face in the live transfer video and interaction the edges with the matching countenances from the datasets, in such cases advancements like AI and preparing datasets are utilized to train the framework to do the means in process.

In one embodiment, the cycle incorporates preparing diverse AI calculations are taken and anchored together to get best outcomes using an initial step to recognize the appearances in the edge or an image, which is an extraordinary component for the artificial intelligence face acknowledgment model 112, where the artificial intelligence face acknowledgment model 112 is allowed to consequently choose faces disregarding different foundations and colors and furthermore it can ensure that the distinguished Face is in great concentration before it recognizes the Face.

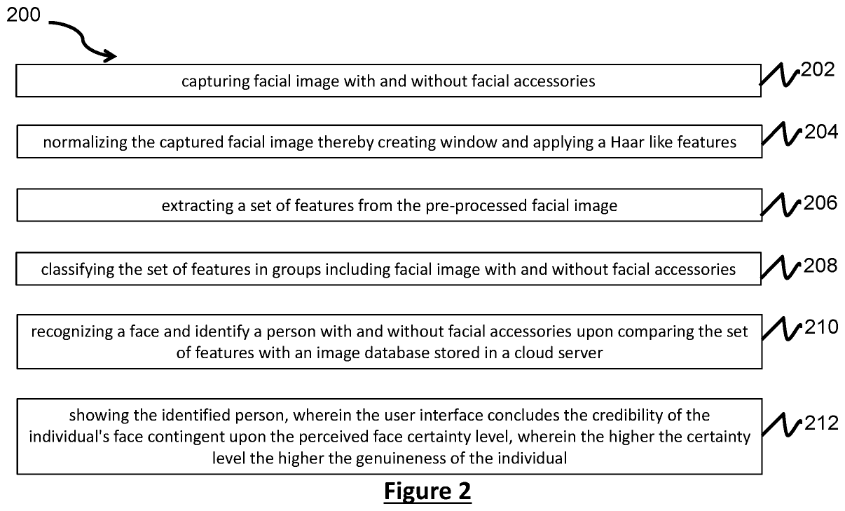

FIG. 2 illustrates a flow chart of a face recognition and identification method in accordance with an embodiment of the present disclosure. At step 202, the method 200 includes capturing facial image with and without facial accessories.

At step 204, the method 200 includes normalizing the captured facial image thereby creating window and applying a Haar like features.

At step 206, the method 200 includes extracting a set of features from the pre-processed facial image.

At step 208, the method 200 includes classifying the set of features in groups including facial image with and without facial accessories.

At step 210, the method 200 includes recognizing a face and identify a person with and without facial accessories upon comparing the set of features with an image database stored in a cloud server 114.

At step 212, the method 200 includes showing the identified person, wherein the user interface 116 concludes the credibility of the individual's face contingent upon the perceived face certainty level, wherein the higher the certainty level the higher the genuineness of the individual.

The system manages constant acknowledgment of appearances by request of pictures being recorded in a camcorder 102. The main utilization of face goal is chiefly for managing the security prerequisite. This part involves distinguishing, recording, and diagnosing of appearances. Bountiful endeavors are advanced on face acknowledgment for a 2-Dimensional (2D) power pictures. However, a total report hasn't been done in recognizing an undividable by achieving different strategies for detecting like 3-Dimensional (3D) or reach information IR symbolism.

In one embodiment, the above figure addresses the framework level engineering where the gadget utilized for the execution of the undertaking is Raspberry Pi 3 model B+ (control unit 110), The working framework utilized is raspberries and the working framework generally separates into client namespace and bit namespace, the Docker motor is introduced on the working framework with upheld ARM design pairs to run the Docker motor to have holders.

Libraries and modules and conditions that are needed to run the AI model 112 face acknowledgment application on IoT stage are packaged inside the compartment to give the seclusion from different conditions. Application concludes the credibility of the individual's face contingent upon the perceived face certainty level, the higher the certainty level the higher the genuineness of the individual.

For the most part, IoT cloud-based is one of the methodologies in IoT world, where the calculation of the application and information is being broke down and checked on the cloud 114. This methodology has both advantaged and hindered, where in our methodology one of our central goal is to bring the calculation close to the IoT gadget, in not many case the calculation should be done over IoT gadget rather than sending every one of the information to the cloud 114 for calculation and information examination.

In one embodiment, IoT cloud-based methodology is Homogenous methodologies where the stage that is handling and investigating the information has a normalized equipment with generally explicit CPU engineering stages. This model 112 of approach has homogenous equipment, comparative standard correspondence conventions, the application layer might vary for one framework to other framework and administration the executives are normalized, this makes simple for general applications where information from the IoT gadgets are spilled to cloud motors for calculation, information investigation, process the information and to be checked.

In one embodiment, in this methodology IoT gadgets simply stream the gathered information from sensors and other fringe gadgets and convey over standard IoT conventions like MQTT, CoAP and so on to send the information to the cloud motors.

In one embodiment, the principal benefits and disservices are recorded beneath Advantages—Checking Services—Highly Accessible Cloud stage—Device network stage—Fast information handling and investigation. The Artificial Intelligence face acknowledgment model 112 is intended to identify, catch, and perceive the Face from a picture.

In one embodiment, the model 112 is carried out to such an extent that it works (runs) on various processors like ARM, AMD, X86, Intel, and so on the principal objective is to foster face acknowledgment AI model 112 that is appropriate to settle on choices for locking or opening the entryway framework as a utilization case and to send the created AI model 112 in a Docker Container. This model 112 can settle on choices dependent on preparing and dataset. Numerous countenances and names are planned and are utilized as preparing sets to the framework.

This acknowledgment model framework utilizes profound learning and picture handling strategies to distinguish the Face in the live transfer video and interaction the edges with the matching countenances from the datasets. In such cases advancements like AI and preparing datasets are utilized to train the framework to do the means in process.

The cycle incorporates preparing diverse AI calculations are taken and anchored together to get best outcomes. The initial step is to recognize the appearances in the edge or an image, this is an extraordinary component for the framework where the framework can consequently choose faces disregarding different foundations and colors and furthermore it can ensure that the distinguished Face is in great concentration before it recognizes the Face.

To begin observing countenances in a casing, the casing is changed over in to highly contrasting picture on the grounds that to diminish the size of the casing that aides in expanding the handling speed then each and every pixel in the edge at single time is viewed as that are straightforwardly encompassing it.

The developed system facilitates face recognition and identification using IOT and deep learning approach that involves the philosophy of fostering the containerized AI model 112. The method is picked for preparing the calculation to such an extent that it distinguishes the countenances caught by our camera 102, which is associated with the assistance of CSI connector. The calculation incorporates the idea of Deep Learning which is a subset of Artificial Intelligence. The strategy comprises of a few stages, for instance, Deep taking in technique identifies the appearances from the picture, and afterward the picture is changed over to a bunch of angles. These angles can be changed over again to milestones to consider the central places of the picture and afterward the preparation step is performed utilizing the Support Vector Machine classifier 108. At last, the approved client is perceived. Our exploration work involves the strategy of fostering the containerized AI model 112 and conveying the containerized application on the Raspberry Pi (control unit 110) (IoT gadget), which comprises of the ARM processor. It is inferred that the containerized application run with high effectiveness, is versatile and adaptable between various stages, and the containerized application is viable with different structures (ARM, x86, amd64).

The principal objective of the developed system is to ensure the machines begin to get information all alone with no help from the developer and they adjust to changing circumstances and given activities. Simulated intelligence and AI are generally utilized reciprocally, especially inside the domain of colossal data. In any case, this is certainly not a comparative variable, and it's important to get a handle on how these are frequently applied in any case. Man-made consciousness could be a more extensive origination than AI that tends to the work of PCs to imitate the mental element elements of people. Right when machines take care of tasks subject to computations in a more intelligent manner, that is AI.

AI could be a great deal of Artificial Intelligence and spotlights on the force of machines to get a social occasion of information and find out on their own, routinely changing estimations as they come out as comfortable with the information, they are taking care of.

Like ML, “profound Learning” is in like manner a method that concentrates features or attributes from rough informational collections. The focal matter of differentiation is DL does this by utilizing a multi-facet Artificial neural organization with many covered layers stacked in a consistent movement. DL moreover has, somewhat, logically present-day calculations and requires all the more impressive computational assets.

These are incredibly made PCs with elite execution CPUs or GPUs. Most profound learning methods use neural organization plans, which is the explanation profound learning models are routinely suggested as profound neural frameworks. The articulation “profound” signifies the number of covered layers in the neural organization. Ordinary neural frameworks simply hold back 2-3 secret layers, while profound neural organizations can have as much as 150. Artificial neural organizations (ANNs) are processing frameworks that are really enlivened by natural neural organizations. Artificial neural organizations (ANNs) are the frameworks inside the neural organizations. Such systems learn (legitimately upgrade their ability) to tackle tasks by pondering points of reference, overall without undertaking express programming. Normally, neurons are coordinated in layers. Later some time, thought focused on organizing unequivocal intellectual abilities, inciting deviations from science, for instance, back proliferation, or passing information in the change bearing and adjusting the framework to reflect that information.

In another embodiment, the fundamental target of the proposal is to foster an AI-based face acknowledgment model 112 (which is carried out after the Deep Learning technique) for the security framework for settling on choices to lock or open the entryway framework and to convey the created AI model 112 in a Docker Container on an IoT stage. The fundamental point of the proposition is accomplishing the edge registering idea that brings the Artificial Intelligence (through our AI model 112) to the low power Internet of Things (IoT) gadgets with the assistance of containerization idea. Containerization would be like the virtualizations. Docker compartments are not difficult to port on different IoT gadgets (Firefly rk3399). Alongside the transportability, Docker incorporates every one of the conditions and modules needed for running the application in a compartment.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A face recognition and identification system, the system comprises:
a camcorder configured to capture facial image with and without facial accessories;
an image pre-processing unit to normalize the captured facial image thereby create window and apply a Haar like features;
a feature extraction unit to extract a set of features from the pre-processed facial image;
a classifier to classify the set of features in groups including facial image with and without facial accessories;
a control unit comprises an artificial intelligence face acknowledgment model to recognize a face and identify a person with and without facial accessories upon comparing the set of features with an image database stored in a cloud server; and
a user interface to show the identified person, wherein the user interface concludes the credibility of the individual's face contingent upon the perceived face certainty level, wherein the higher the certainty level the higher the genuineness of the individual.

2. The system as claimed in claim 1, wherein the calculation of the user interface and information is being broke down and checked on the cloud server using artificial intelligence face acknowledgment model.

3. The system as claimed in claim 1, wherein the control unit is configured to stream the captured facial image and convey over standard IoT conventions like MQTT, CoAP and so on to send the information to the cloud motors.

4. The system as claimed in claim 1, wherein the user interface is configured with a display unit and a set of input and peripheral devices to promote checking services for highly accessible cloud stage and device network stage for information handling and investigation.

5. The system as claimed in claim 1, wherein the artificial intelligence face acknowledgment model is intended to identify, catch, and perceive the Face from a picture, wherein the artificial intelligence face acknowledgment model is carried out to such an extent that it works (runs) on various processors like ARM, AMD, X86, Intel, and so on.

6. The system as claimed in claim 1, wherein the artificial intelligence face acknowledgment model is configured with one of the central locking system and authentication system to settle on choices for locking or opening the entryway framework as a utilization case and to send the created AI Model in a Docker Container.

7. The system as claimed in claim 6, wherein the artificial intelligence face acknowledgment model is allowed to settle on choices dependent on preparing and dataset, wherein numerous countenances and names are planned and are utilized as preparing sets to the framework.

8. The system as claimed in claim 6, wherein the artificial intelligence face acknowledgment model utilizes profound learning and picture handling strategies to distinguish the Face in the live transfer video and interaction the edges with the matching countenances from the datasets, in such cases advancements like AI and preparing datasets are utilized to train the framework to do the means in process.

9. The system as claimed in claim 8, wherein the cycle incorporates preparing diverse AI calculations are taken and anchored together to get best outcomes using an initial step to recognize the appearances in the edge or an image, which is an extraordinary component for the artificial intelligence face acknowledgment model, where the artificial intelligence face acknowledgment model is allowed to consequently choose faces disregarding different foundations and colors and furthermore it can ensure that the distinguished Face is in great concentration before it recognizes the Face.

10. A face recognition and identification method, comprising:
capturing facial image with and without facial accessories;
normalizing the captured facial image thereby creating window and applying a Haar like features;
extracting a set of features from the pre-processed facial image;
classifying the set of features in groups including facial image with and without facial accessories;
recognizing a face and identify a person with and without facial accessories upon comparing the set of features with an image database stored in a cloud server; and
showing the identified person, wherein the user interface concludes the credibility of the individual's face contingent upon the perceived face certainty level, wherein the higher the certainty level the higher the genuineness of the individual.
